(19) United States
(12) Patent Application Publication
(10) Pub. No.: US 2025/0128449 A1
(43) Pub. Date: Apr. 24, 2025

(54) COLLAPSIBLE WOVEN BASKET AND METHOD OF MAKING SAME

(71) Applicant: Seville Classics Inc., Torrance, CA (US)

(72) Inventor: Chi-Jeh Yang, Changhua County (TW)

(73) Assignee: Seville Classics Inc., Torrance, CA (US)

(21) Appl. No.: 18/381,919

(22) Filed: Oct. 19, 2023

(51) Int. Cl. B27J 1/02

(52) U.S. Cl. CPC B27J 1/02

(57) ABSTRACT

A method is provided for making a collapsible woven basket which has four frame members. According to the method, the right side of each frame member is connected to the left side of an adjacent frame member to form pivoting connections. Vertical bands are formed by wrapping a vertical strip of material around the top and bottom sides of the four frame members in a manner where a vertical space is defined between adjacent vertical bands. Next, horizontal bands are formed by threading a horizontal strip of material inside and outside adjacent vertical bands in each frame member, with this threading starting from adjacent the bottom side of the first frame member and repeated to the top side for each frame member. With this method of forming vertical and horizontal bands, each horizontal band covers each pivoting connection between adjacent frame members.

### BACKGROUND OF THE INVENTION

### 1. Field of the Invention

The present invention relates to a collapsible woven basket or hamper, and in particular, to a method for weaving the basket or hamper that can be collapsed.

### 2. Description of the Prior Art

The recent trend for household storage items is to provide baskets, hampers, racks and other containers that can be collapsed into a smaller configuration so that they can be more easily shipped or packed when they are not in use.

There are currently a number of collapsible baskets and hampers that are available in the marketplace. These collapsible baskets and hampers are foldable about their connecting edges so that they can be folded and collapsed into a smaller configuration. The smaller configuration means that the packaging can be made smaller, and also facilitates less expensive shipping as the product occupies less space.

For these collapsible baskets and hampers, cloth and meshed materials are often used for their sidewalls, but cloth and meshed materials are not durable and cannot tolerate too much wear and tear. As a result, collapsible baskets and hampers are also being made with bamboo or sturdier materials for the side walls. These collapsible baskets and hampers are often woven with strips of bamboo or a similar sturdy material. When weaving the strips of bamboo in making these collapsible baskets or hampers, the pivoting or folding edges between each adjacent sidewall have a noticeable and sizeable gap to facilitate the easy folding of the sidewalls against each other. However, these gaps between adjacent sidewalls are not desirable when the hamper or basket is in use.

### SUMMARY OF THE DISCLOSURE

It is an object of the present invention to provide a collapsible woven basket or hamper that can be easily folded and collapsed while minimizing the gap between adjacent sidewalls.

It is another object of the present invention to provide a method for weaving a collapsible basket or hamper that minimizes the gap between adjacent sidewalls.

The objectives of the present invention are accomplished by providing a method of making a collapsible woven basket which has a first frame member, a second frame member, a third frame member and a fourth frame member, with each frame member having a left side, a right side, a bottom side and a top side. According to the method, the right side of each frame member is connected to the left side of an adjacent frame member to form pivoting connections. Vertical bands are formed by wrapping a vertical strip of material around the top and bottom sides of the four frame members in a manner where a vertical space is defined between adjacent vertical bands. Next, horizontal bands are formed by threading a horizontal strip of material inside and outside adjacent vertical bands in the first frame member, and then continuing to thread the horizontal strip of material inside and outside adjacent vertical bands in the second frame member, the third frame member and the fourth frame member, with this threading starting from adjacent the bottom side of the first frame member and repeated to the top side for each frame member. With this method of forming vertical and horizontal bands, each horizontal band covers each pivoting connection between adjacent frame members.

### BRIEF DESCRIPTION OF THE DRAWINGS

FIG. 1 is a perspective view of a woven basket according to the present invention.

FIG. 2 is a perspective view of the basket of FIG. 1 showing the base lifted up.

FIG. 3 is an enlarged view of the weave pattern of the basket of FIG. 1.

FIG. 4 is a side corner view of one corner of the basket of FIG. 1.

FIG. 5 is a perspective view of the underlying frame members of the basket of FIG. 1.

FIGS. 6-12 illustrate how the frame members of FIG. 5 are woven by one or more strips of material.

FIG. 13 is an exploded bottom perspective view of the basket of FIG. 1.

FIG. 14 is a bottom perspective view of FIG. 13 showing the base pivotably connected to the four side members.

FIGS. 15-16 illustrate how the basket of FIG. 1 is collapsed.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims. In certain instances, detailed descriptions of well-known devices and mechanisms are omitted so as to not obscure the description of the present invention with unnecessary detail.

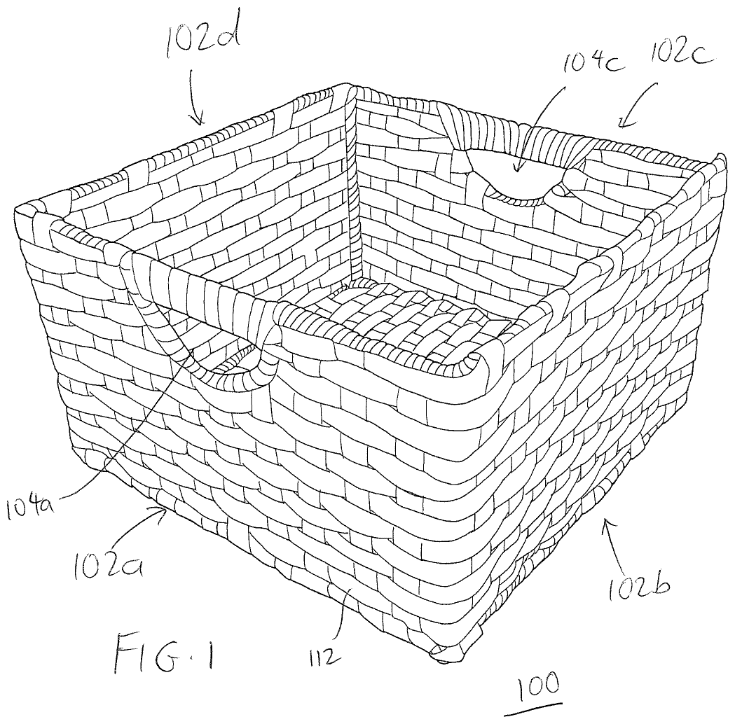

FIGS. 1-4 illustrate one embodiment of a collapsible woven basket 100 according to the present invention. Even though the invention is illustrated herein in connection with a basket, it is possible to use the same structural elements and apply the same steps to provide a collapsible woven hamper or other similar container.

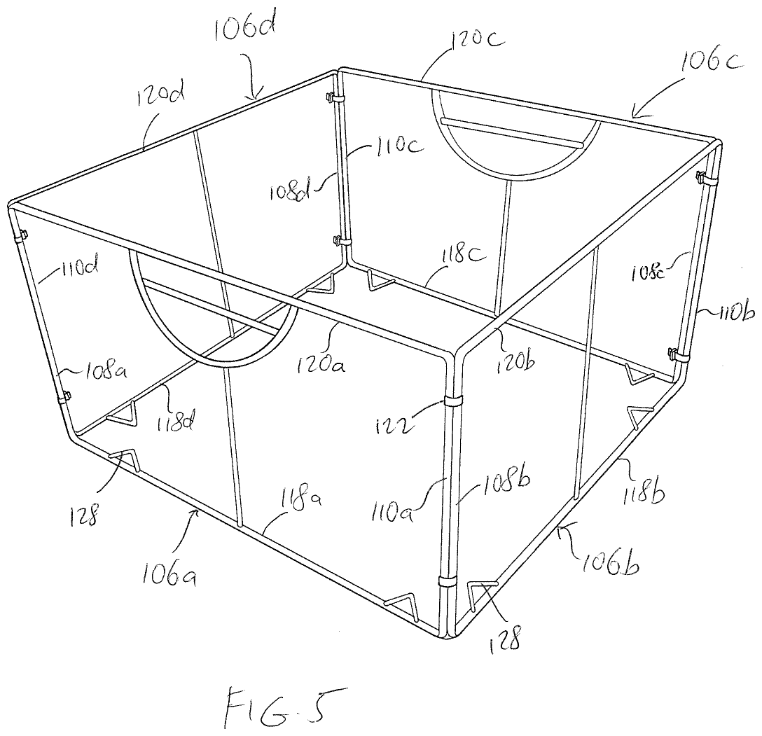

The basket 100 has four side members 102a, 102b, 102c and 102d, with two opposite side members 102a and 102c having an opening 104a and 104c adjacent the upper edge thereof to function as handles. Each side member 102a-102d has an underlying frame member 106a-106d, respectively. See FIG. 5. Each side member 102a-102d has a left side 108a-108d, a right side 110a-110d, a bottom side 118a-118d and a top side 120a-120d. The four side members 102a-102d are pivotably connected to each other in a manner where each frame member (e.g., 106a) has two opposite sides (e.g., left side 108a and right side 110a as shown in FIG. 5) that are pivotably connected to sides (e.g., right side 110d and left side 108b) of two adjacent frame members (e.g., 106d and 106b), respectively. In addition, a ringed connector 122 can be used to pivotably connect the two adjacent sides (e.g., right side 110a and left side 108b) of two adjacent frame members 106a and 106b. Each ringed connector 122 can be cut and removed after the weaving of the strip(s) 112 as described below has been completed.

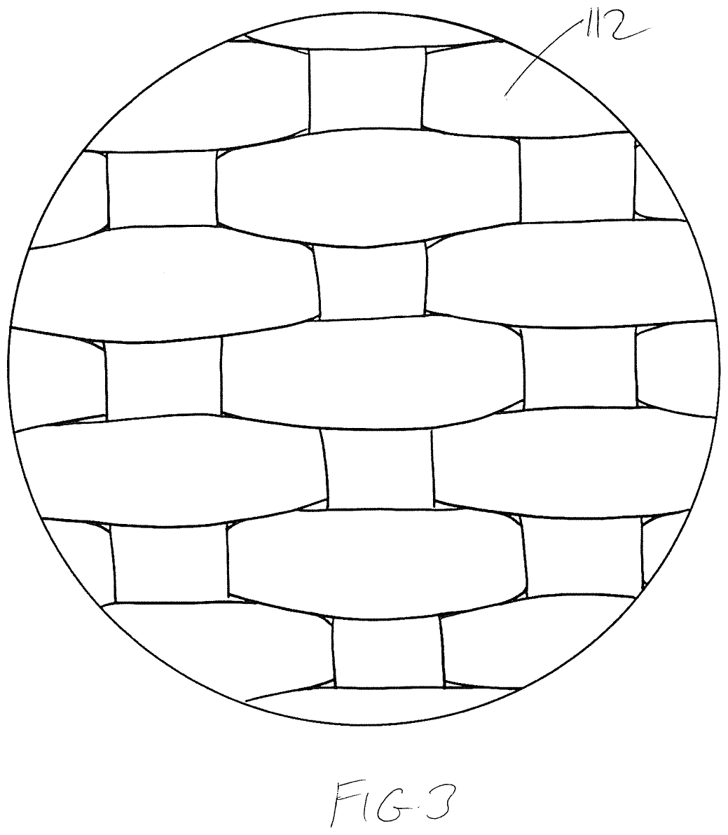

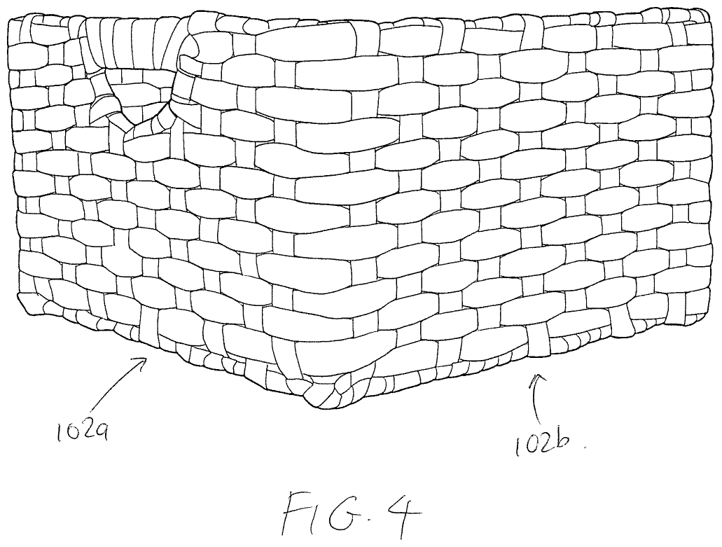

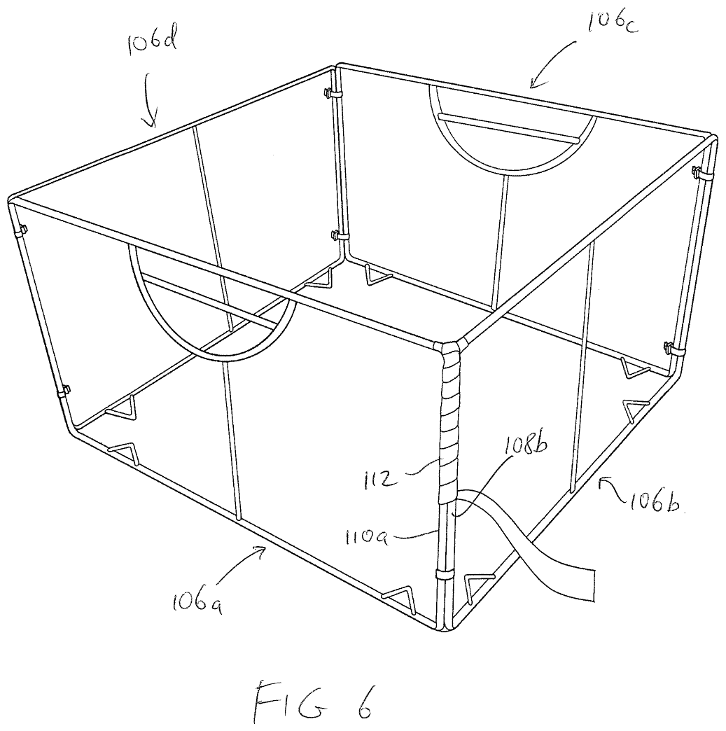

Each side member 102-102d is woven by one or more strips 112 of material using a weave pattern that is shown in greater detail in FIG. 3, and which is woven according to the weave method shown in FIGS. 6-12 and described below. As best shown in FIG. 4, the weave pattern covers each pivoting connection at the four corners of the basket 100. The strip of material used for weaving is preferably made of a flexible, and more preferably, elastic, material because it is fully stretched (especially at four corners). Examples include polyethylene, paper cord, rope, bamboo and rattan.

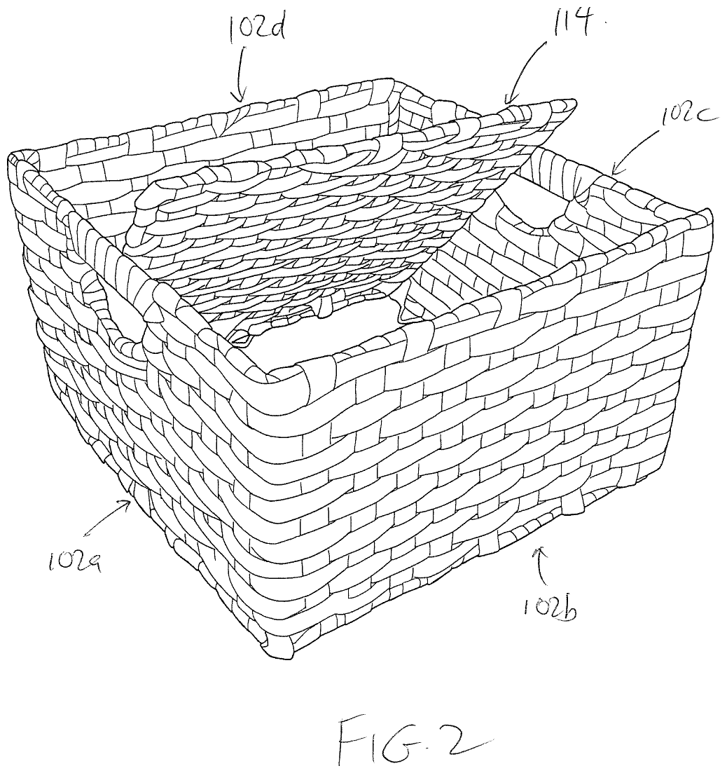

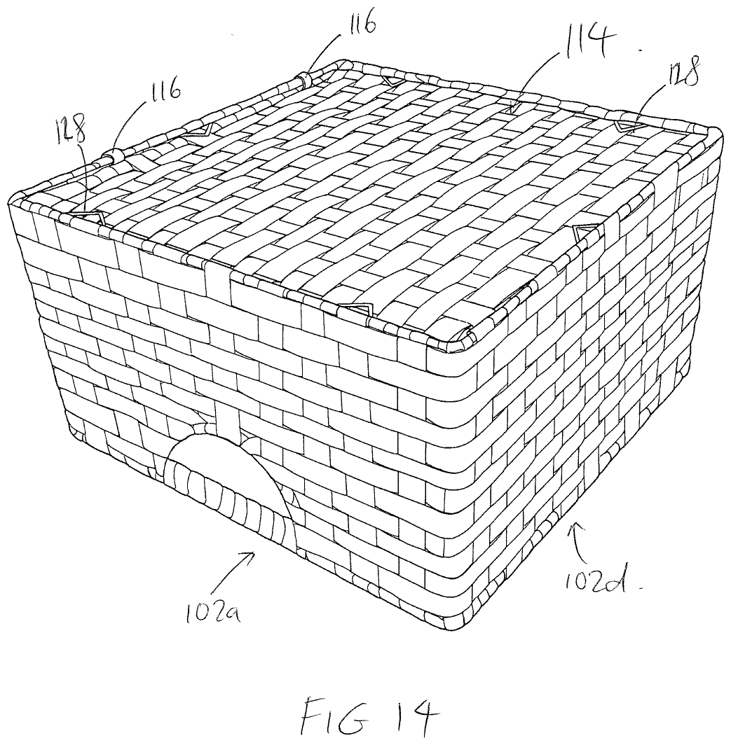

A base 114 that is also made of a frame member (not shown) that is woven using the weave pattern of FIG. 3 according to the weaving steps shown and described below has one side that is pivotably connected to a bottom side 118a-118d of one of the side members 102a-102d by one or more ringed connectors 116. See FIGS. 2 and 14. The ring connectors 116 can also be made from the same material that is used to form the weave pattern. A plurality of angled members 128 can be provided in spaced-apart manner along the bottom sides of each side member 102a-102d so that the base 114 can be seated on this border of angled members 128, thereby preventing the base 114 from being pivoted outside the interior defined by the four side members 102a-102d. Each of the angled members 128 can be a metal strip that is bent to form the angled configuration.

FIGS. 6-12 illustrate the method of weaving:

Step One: Connecting two Adjacent Sides. The weaving method begins with first weaving the two adjacent sides (e.g., right side 110a and left side 108b) of two adjacent frame members (e.g., 106a and 106b). As shown in FIG. 6, a strip 112 of material is wound around the two adjacent sides 110a and 108b to completely cover the connection between these two sides 110a and 108b.

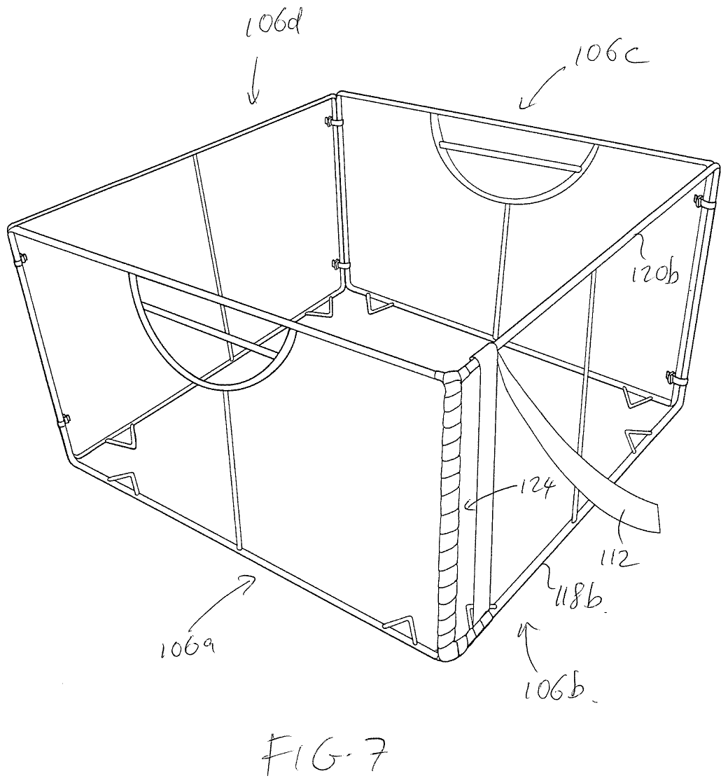

Step Two: Forming Vertical Bands. The same strip 112 is then wound around the bottom side 118b of the frame member 106b for a couple of wraps and then is extended from the inside of the bottom side 118b to the outside of the top side 120b with a small vertical space 124 between the left side 108b and the extended band of the strip 112. See FIG. 7. The same strip 112 is then wound around the top side 120b for a couple of wraps and then is extended from the inside of the top side 120b to the outside of the bottom side 118b with another small vertical space 124 between the two adjacent bands of the strip 112. The same strip 112 is then wound around the bottom side 118b for a couple of wraps and then is extended from the outside of the bottom side 118b to the inside of the top side 129b with another small vertical space 124 between the two adjacent bands of the strip 112. These vertical bands can be formed for the entire frame member 106b, and then Step One can be repeated using the same strip 112 for the two adjacent sides (e.g., right side 110b and left side 108c) of the next two adjacent frame members (e.g., 106b and 106c).

It should be noted that the vertical wrap method involves an inside-to-outside (or outside-to-inside) wrap from one of the top side and bottom side to the other of the bottom side and top side.

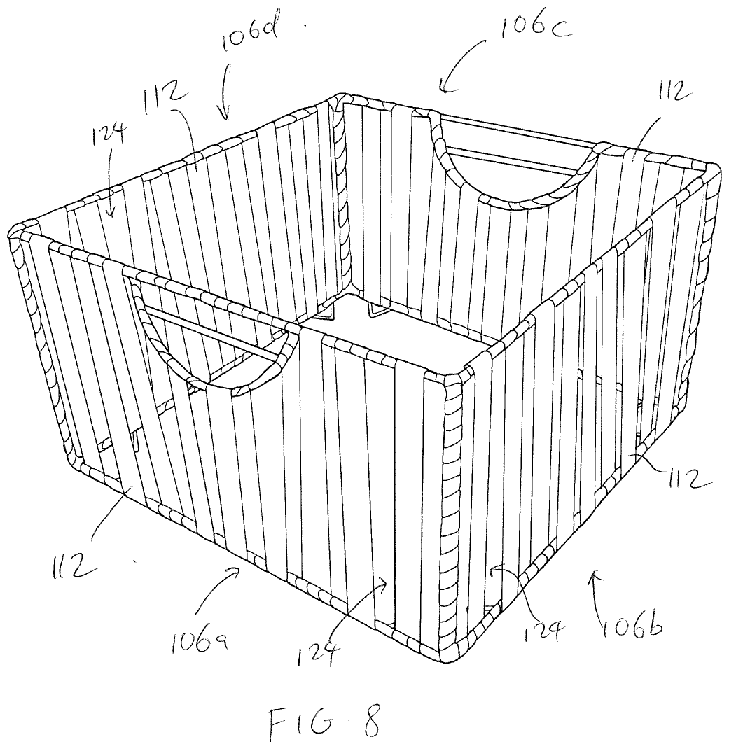

This process of wrapping around the top sides 120a-120d and the bottom sides 118a-118d to form bands of the strip 112 with vertical spaces 124 between adjacent bands of the strip 112 is repeated for the remaining two frame members 106c and 106d. The result is shown in FIG. 8 where all four frame members 106a-106d have been wrapped with the vertical bands. At the locations of the handles 104a and 104c, the strip 112 is wrapped around the curved portion of the handle which functions like a top side 120a-120d.

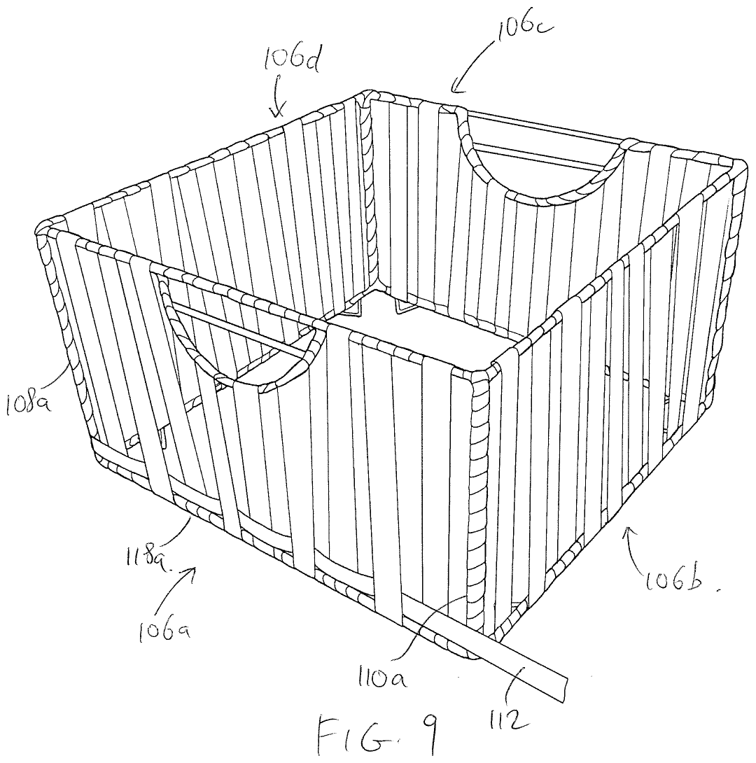

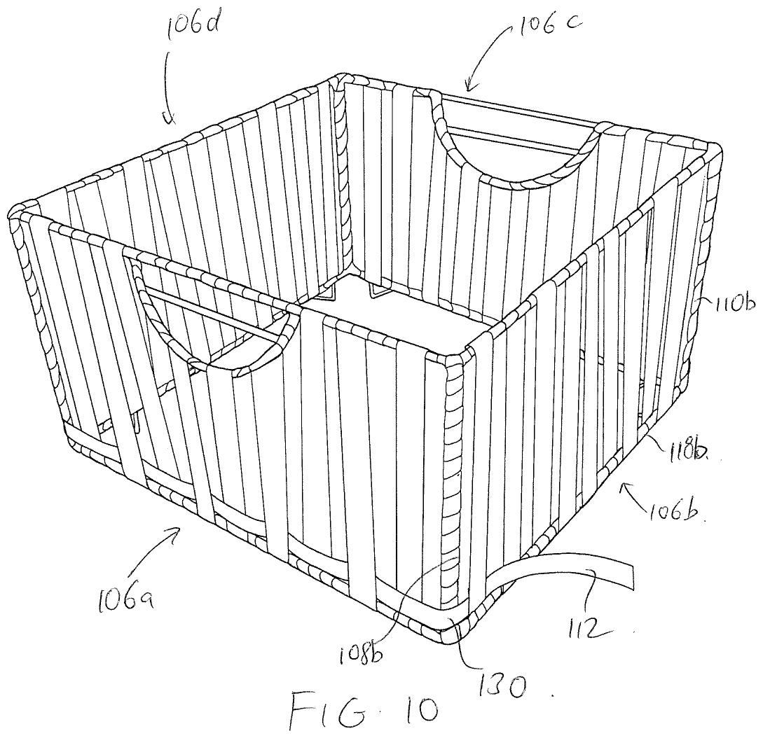

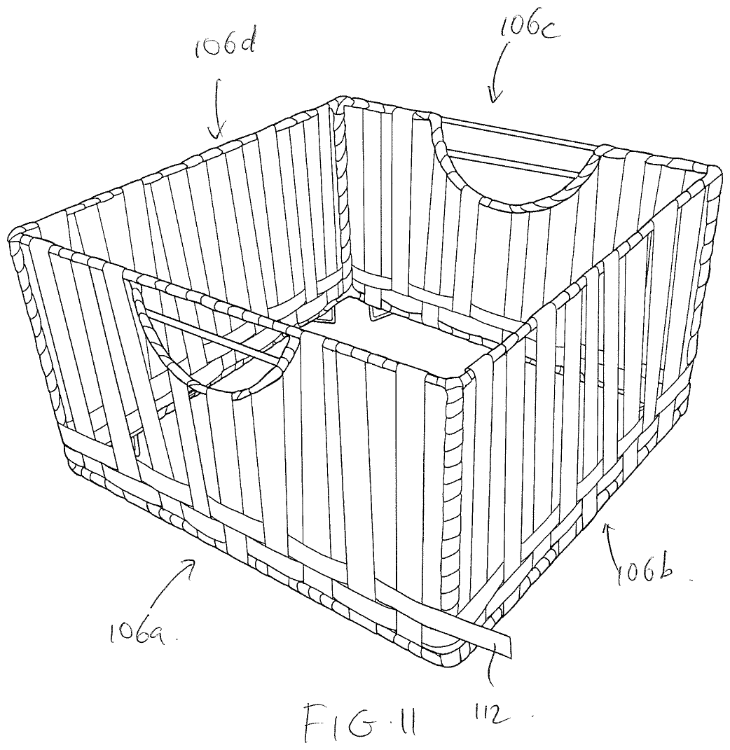

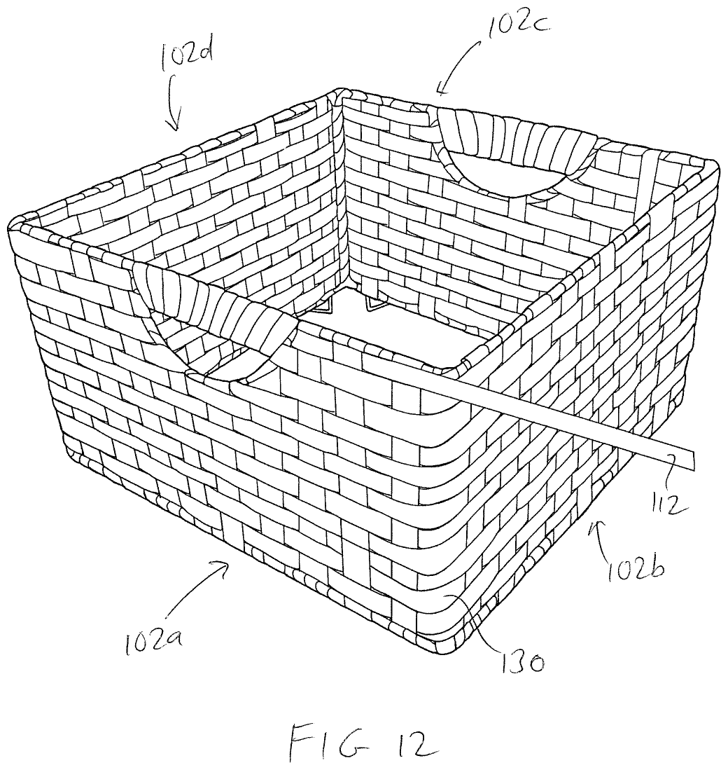

Step Three: Forming Horizontal Bands. Referring to FIG. 9, the same strip 112, or a new strip 112, is threaded along the bottom side 118a of the frame member 106a from the left side 108a towards the right side 110a. The threading involves passing the strip 112 in front of one vertical band and then behind the adjacent vertical band in alternating fashion. When the strip 112 reaches the right side 110a, it wraps around the pivoting connection between the sides 110a and 108b (see bend 130 in FIG. 10) and then the strip 112 is now threaded along the bottom side 118b of the frame member 106b from the left side 108b towards the right side 110b. This threading and wrapping continues around the other frame members 106c and 106d to form a first horizontal row or band of the strip 112, as shown in FIG. 11, and then the strip 112 is threaded and wrapped in the same manner to form a second horizontal row or band of the strip 112. The threading is preferably done so that the vertical bands that are inside the first horizontal band are now outside the second horizontal band, and the vertical bands that are outside the first horizontal band are now inside the second horizontal band, so as to provide an alternating “in” and “out” weave for adjacent rows of horizontal bands and adjacent vertical bands. This process is continued until all the horizontal bands are formed, as shown in FIG. 12. The resulting weave pattern is best shown in FIG. 3.

As shown in FIG. 12, the horizontal bands are wrapped in a manner where the bend 130 at each corner covers any vertical space that may exist if each frame member 106a-106d were to be woven separately.

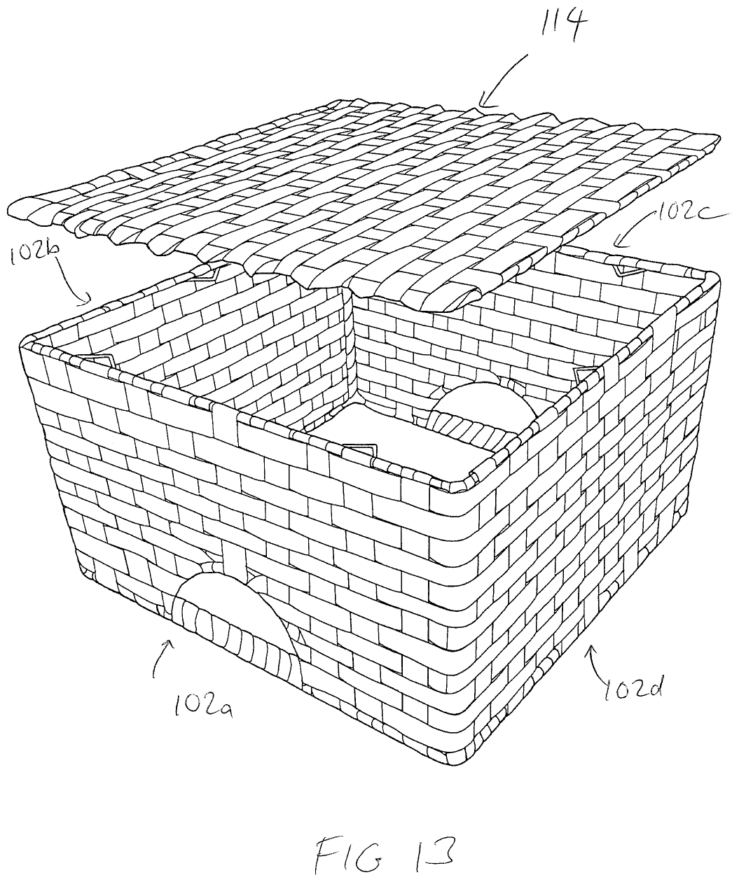

FIGS. 13 and 14 show the provision of the base 144 and how it is secured to the bottom sides 118a-118d.

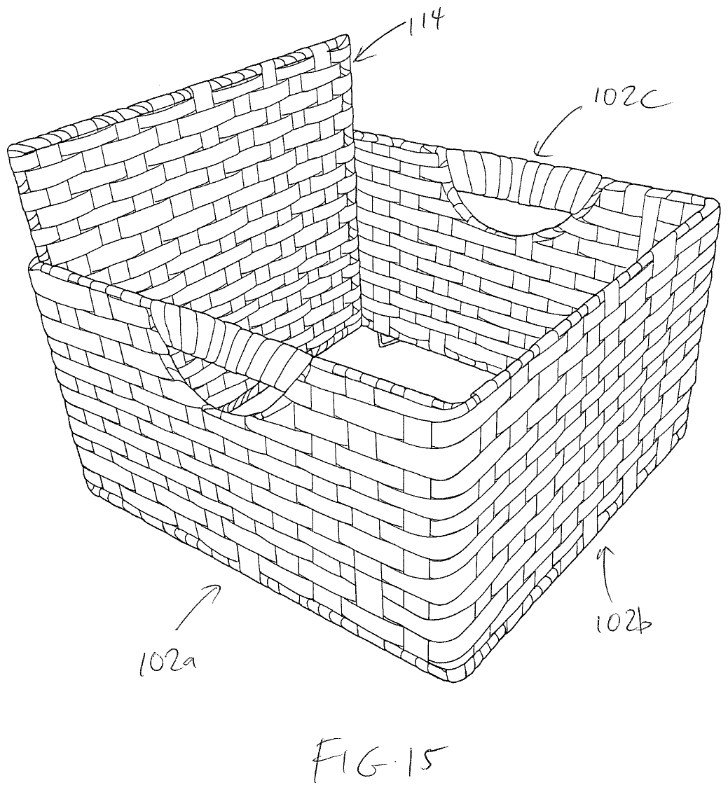

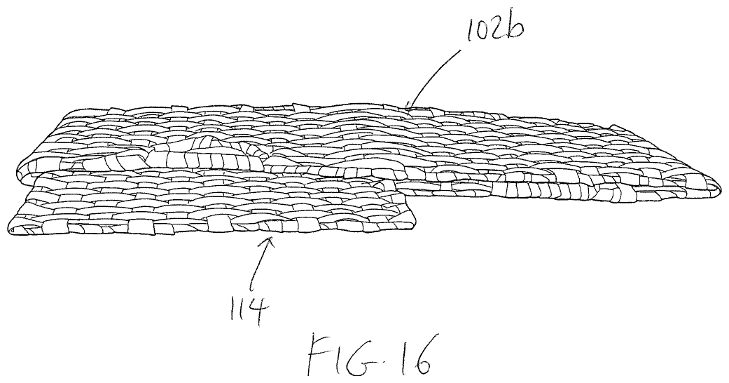

FIGS. 15-16 show how the basket 100 is folded and collapsed. The base 114 is first pivoted about the ring connectors 160 towards the interior formed by the four side members 102a-102d so that the base 114 is positioned against the inside of the side member 102d. See FIG. 15. The entire structure is then folded about the pivoting connections of the adjacent sides so that the four side members 102a-102d can be positioned flat against each other (with the base 114 positioned inside) to form a stack of side members 102a-102d and the base 114.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A method of making a collapsible woven basket, comprising:
providing a first frame member, a second frame member, a third frame member and a fourth frame member, each frame member having a left side, a right side, a bottom side and a top side;
connecting the right side of each frame member to the left side of an adjacent frame member to form pivoting connections;
forming vertical bands by:
wrapping a vertical strip of material around the bottom side of the first frame member adjacent the left side of the first frame member,
extending the vertical strip of material to the top side of the first frame member to create a first vertical band,
wrapping the vertical strip of material around the bottom side of the first frame member,
extending the vertical strip of material back to the bottom side of the first frame member to create a second band with a vertical space defined between the first and second bands, and
repeating the above wrapping and extending steps until vertical bands are formed for all the frame members;
forming horizontal bands by:
starting from adjacent the bottom side of the first frame member, threading a horizontal strip of material inside and outside adjacent vertical bands in the first frame member, and then continuing to thread the horizontal strip of material inside and outside adjacent vertical bands in the second frame member, the third frame member and the fourth frame member, and
repeating the step of threading a horizontal strip of material until horizontal bands are formed from the bottom side to the top side for each frame member;
wherein each horizontal band covers each pivoting connection between adjacent frame members.

2. The method of claim 1, further including the step of pivotably connectiig a base to the bottom side of the fourth frame member.

3. The method of claim 1, wherein the steps of wrapping a vertical strip of material around the bottom side of the first frame member and extending the vertical strip of material to the top side of the first frame member to create a first vertical band includes wrapping a vertical strip of material around the bottom side of the first frame member and extending the vertical strip of material from the inside of the bottom side of the first frame member to the outside of the top side of the first frame member.
